(19) United States
(12) Patent Application Publication
(10) Pub. No.: US 2015/0051830 A1
(43) Pub. Date: Feb. 19, 2015

(54) ENHANCED NAVIGATION

(71) Applicant: Ford Global Technologies, LLC, Dearborn, MI (US)

(72) Inventor: Salman Nazir Shami, City Doreen (AU)

(73) Assignee: Ford Global Technologies, LLC, Dearborn, MI (US)

(21) Appl. No.: 13/965,728

(22) Filed: Aug. 13, 2013

(51) Int. Cl. G01C 21/36

(52) U.S. Cl. CPC G01C 21/3629
USPC 701/468; 701/400; 701/538

(57) ABSTRACT

A computer receives input to generate a route. The route is generated according to the input. Custom route data is received indicating a first portion of the route, the first portion of the route being a portion of the route for which audio navigational assistance is to be provided. Navigational instructions as a route is traversed, wherein audio navigational assistance is provided for the first portion of the route but not for a second portion of the route.

### BACKGROUND

In-vehicle navigation systems, e.g., using the global positioning system (GPS), or the like, may provide users with navigational assistance, recommendations and/or instructions concerning a route or routes for traversing from a start point to an end point. However, users often begin and/or and trips from locations or geographic areas with which they are familiar. Unfortunately, existing navigation systems do not discriminate between geographic areas for which users desire navigational assistance, and geographic areas or locations where navigational assistance is not desired, or for which a level of navigational assistance may be reduced. For example, navigational systems do not selectively provide audio, e.g., voice, navigation instructions based on areas with which a user is unfamiliar. Accordingly, current systems may undesirably, and unnecessarily, provide driver distractions and/or interfere with a vehicle's audio environment.

### DRAWINGS

FIG. 1 is a block diagram of an exemplary enhanced navigation system.

FIG. 2 is a diagram of an exemplary process for enhanced navigation.

### DETAILED DESCRIPTION

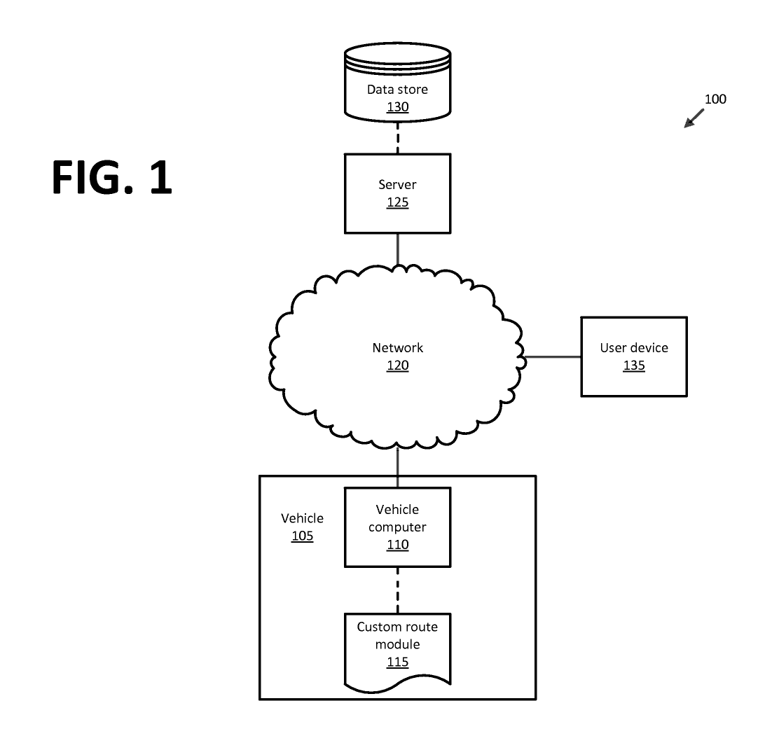

FIG. 1 is a block diagram of an exemplary enhanced navigation system 100. A vehicle 105 includes a vehicle computer 110 that may be configured to perform various operations in the vehicle 105, including navigation, e.g., using the global positioning system (GPS) or the like. Accordingly, the computer 110 generally includes instructions for providing vehicle 105 navigation, including a custom route module 115 that generally includes instructions for customizing a vehicle 105 route for a user. The custom route module 115 generally utilizes custom route data that identifies one or more locations, geographic areas, etc., with which a user is familiar, and for which a user does not require and/or desire audible navigational guidance. Accordingly, the instructions for customizing a vehicle 105 route included in the custom route module 115 may include instructions for providing or not providing audible navigational guidance for respective segments of a generated route. Further, the computer 105 may communicate with a server 125 via a network 120, e.g., to obtain various data, including custom route data, from, or provide data to, a data store 130.

The computer 110 may be any one of a number of known computing devices, such as a dedicated GPS device, a smart phone configured for GPS navigation, an in-vehicle computer that includes navigation functionality, etc. Further, the disclosed computer 110 may represent more than one computing device; for example, a smart phone computing device paired to an in-vehicle computer, e.g., via Bluetooth, may be represented by the computer 110. Regardless of a type of computer 110, the computer 110 generally includes a processor and a memory, the memory including one or more forms of computer-readable media, and storing instructions executable by the processor for performing various operations, including as disclosed herein, e.g., the custom route module 115. In general, e.g., using the custom route module 115, the computer 110 stores and executes, e.g., with the afore-mentioned memory and processor, instructions to perform operations as described herein. The computer 110 is generally configured for communications on various networks, including the network 120 described below, and other wired and/or wireless networks, such as using Bluetooth communications, a controller area network (CAN) bus, etc.

It should be noted that, although the computer 110 is shown in FIG. 1, and described herein, as being included in the vehicle 105, the computer 110, e.g., a smart phone, could be used to provide navigational assistance as disclosed herein when not in a vehicle, e.g., when a user is on foot, or on, rather than in, a vehicle such as a bicycle or motorcycle.

As mentioned above, the custom route module 115 generally makes use of custom route data. In the context of the present disclosure, custom route data includes information concerning a geographic area, one or more routes, particular streets, landmarks, etc., with which a user is familiar. Custom route data for a particular user may be stored in a memory of the computer 110, and/or may be retrieved from storage in the data store 130 is via the server 125. For example, a user may provide custom route data via an interface, e.g., a touchscreen interface, and interactive voice response system, etc., of the computer 110, specifying an area or areas with which the user is familiar, and/or, after a route is generated, specific portions of the route for which the user does not require audible navigational assistance. Alternatively or additionally, a user may provide custom route data to the server 125, which could store the data in the data store 130, using a client device 135, e.g., a personal computer, tablet computer, smart phone, etc., that accesses a webpage or the like provided by the server 125, and that allows a user to specify a geographic area or areas with which the user is familiar, and for which the user does not desire audible navigational assistance, e.g., a voice providing turn-by-turn route instructions.

The network 120 represents one or more mechanisms by which a vehicle computer 110 may communicate with a remote server 125. Accordingly, the network 120 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The server 125 may be one or more computer servers, each generally including at least one processor and at least one memory, the memory storing instructions executable by the processor, including instructions for carrying out various of the steps and processes described herein. The server 125 may include or be communicatively coupled to a data store 130 for storing data as described.

A user device 135 may be any one of a variety of computing devices including a processor and a memory, as well as communication capabilities. For example, the user device 135 may be a personal computer, e.g., a laptop or other portable computer, a tablet computer, a smart phone, etc. that includes capabilities for wireless communications using IEEE 802.11, Bluetooth, and/or cellular communications protocols. Further, the user device 135 may use such communications capabilities to communicate via the network 120 and also directly with the vehicle computer 110, e.g., using Bluetooth.

### Exemplary Process Flows

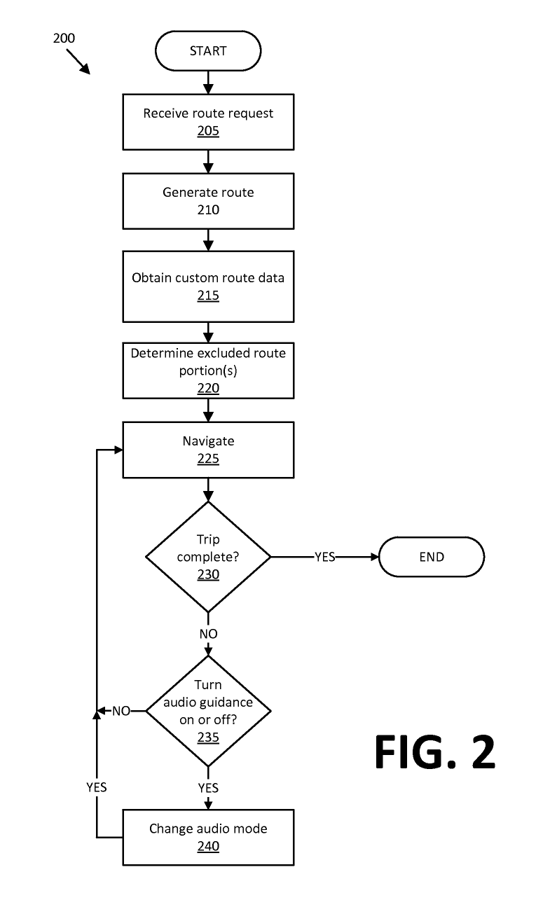

FIG. 2 is a diagram of an exemplary process 200 for enhanced navigation. As described herein, the computer 110 may perform elements of the process 200 according to instructions, e.g., as included in the custom route module 115, stored in a computer readable medium, e.g., memory, of the computer 110 and executed by a processor thereof. Alternatively or additionally, elements of the process 200 could be likewise performed according to instructions stored in and/or executed by the user device 135.

The process 200 begins in a block 205, in which the computer 110 receives input requesting navigation instructions, e.g., a route. As mentioned above, the computer 110 generally includes a navigation module or the like. Further, the computer 110 may include, in a memory thereof, map data, and/or may download map data stored in the data store 130 from the server 125. In any case, the computer 110 generally includes instructions for receiving user input to identify start points and endpoints, e.g., a trip origin point and a trip destination point, and for generating one or more routes between the start and end points. Accordingly, in the block 205, the computer 110 may receive input requesting a route in a known manner, e.g., via a voice interface, a touchscreen interface, etc. For example, a GPS system may determine a present location of a vehicle 105, and may receive user input indicating a destination point, thereby respectively identifying start and end points for a route.

In a block 210, the computer 110 generates a route between an indicated start point and an indicated endpoint. For example, a GPS system may identify a route in the form of a list of intersections at which the vehicle 105 should change a direction, a lane, and/or a street, etc. A route generated by a GPS system generally further includes information concerning respective distances between the aforementioned changes. An example route could be: (1) TURN LEFT ONTO FIRST STREET, 3.2 km; (2) TURN RIGHT ONTO SECOND BOULEVARD, 2.1 km (3) AT THE ROUNDABOUT TAKE THE SECOND EXIT, 500m; (4) TURN RIGHT ONTO THIRD BOULEVARD, 2.3 km; (5) AT THE ROUNDABOUT TAKE FIRST EXIT ONTO FOURTH EXPRESSWAY, 7.1km; (6) TURN RIGHT AT FIFTH STREET AND JOIN THE SIXTH MOTORWAY, 20.1km; (7) EXIT AT RAMP 123 AND TURN RIGHT ONTO SEVENTH STREET, 7.5km; (8) ARRIVE AT DESTINATION ON RIGHT, 1.2 km.

Next, in a block 215, the computer 110 obtains custom route data, e.g., in a manner as described above. For example, as described above, a user could specify a portion or portions of the route generated in the block 210 with which the user was familiar and/or did not wish to receive audible navigation instructions. A user could provide such input to the computer 110, e.g., via a touchscreen or the like wherein the user could select a portion or portions of a route displayed on a map. Likewise, a user could specify a governmental boundary or boundaries such as city, a street, a landmark (e.g., a building, a park, etc.) with which the user was familiar. The computer 110 could include instructions for identifying such a specified area in the custom route data, and/or, at least for certain kinds of areas, e.g., landmarks, could include instructions for identifying an area within a certain distance, or within a certain radius, as being within a specified area of the custom route data for which audible navigation instructions should not be provided. Further, custom route data is generally stored according to geographic coordinates, e.g., latitude and longitude coordinates or geo-coordinates, as are known. For example, with respect to the exemplary route provided above, a user could provide input concerning a point in the route, e.g., when turning right at Fifth Street, at which audible guidance should begin.

Next, in a block 220, the computer 110, using the custom route data, determines a portion or portions of the route generated in the block 210 that should not be accompanied by audible navigation instructions, e.g., turn-by-turn voice navigation. Such determination may generally be made by comparing geographic coordinates (e.g., what are known as geo-coordinates) of segments of a route determined in the block 210 with geographic coordinates identified in the custom route data, or otherwise identifying a location at which audible navigation instructions should commence.

For example, if a location in a route (e.g., “turning right onto Fifth Street”) has been provided from a list of route segments as in the example above, then the computer 110 could simply identify that location, or could, note a number of route segments to be traversed before beginning audible navigation assistance. In the example above, the computer 110 would start audible guidance before the user needs to turn right at Fifth Street.

Following the block 220, in a block 225, the computer 110 begins navigation of the route generated in the block 210. In general, navigation begins with audio navigational assistance turned on or off according to the determination made in the block 220, i.e., whether a first portion of a route is or is not indicated by the custom route data to be suitable for audio navigational assistance. Further, in subsequent iterations of the process 200, navigation continues in the block 225 with audio navigational assistance, e.g., turn-by-turn voice instructions, provided according to the custom route data.

Generally following the block 225, although generally not in a first iteration of the process 200, in a block 230, the computer 110 determines whether navigation is complete, e.g., because a trip is complete. If navigation of the route determined in the block 210 is complete, has been terminated by a user or for some other reason, etc., then the process 200 ends. Otherwise, the process 200 proceeds to a block 235.

In the block 235, the computer 110 determines whether the vehicle 105 has reached a portion of the route being navigated for which audio navigational assistance, e.g., turn-by-turn guidance, should be turned on, if audio systems is presently off, or for which it should be turned off, if it is presently on. If a change needs to be made in the status of audio navigational assistance, then the process 200 proceeds to a block 240. Otherwise, the process 200 returns to the block 225.

In general, the computer 110 determines when audible navigational assistance should be provided according to a route location as described above. Moreover, if the computer 110 detects, e.g., in the block 235, that the vehicle 105 has strayed from the route identified as described above, prior to reaching the audible guidance start point, the computer 110 could request the user to provide input concerning whether the user if they would like to start audible guidance immediately, or at some point before the previously specified location. If the user accepted, then the process 200 would proceed to the block 240. However, if the user declined, the process 200 would proceed to the block 225. Nonetheless, the computer 110 could continue to calculate the distance between the current position of the vehicle 105 and the destination. If, after a predetermined period of time, e.g., 5 minutes, the computer 110 determined that the distance to the destination or end point was increasing, the computer 110 could provide an alert, e.g., audio, video, etc., that the vehicle 105 was increasing its distance from the specified destination. Further, at this point the computer 110 could again, e.g., in a subsequent iteration of the block 235, request input concerning whether the user wanted audio navigational assistance started.

In the block 240, the computer 110 changes in audio mode of navigational assistance, e.g., if audio assistance is presently being provided, the computer 110 may execute instructions for ceasing audio navigational assistance, whereas if audio navigational assistance is not presently being provided, then the computer 110 may execute instructions for beginning audio navigational assistance.

The process 200 generally ends when a trip is complete or navigation is otherwise terminated, e.g., as described above with respect to the block 230.

### Conclusion

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising a computer, the computer comprising a processor and a memory, wherein the computer is configured to:
receive input to generate a route;
generate the route according to the input;
receive custom route data indicating a first portion of the route, the first portion of the route being a portion of the route for which audio navigational assistance is to be provided;
provide navigational instructions as the route is traversed, wherein audio navigational assistance is provided for the first portion but not a second portion of the route.

2. The system of claim 1, wherein the first portion of the route includes one of a start point of the route and an end point of the route.

3. The system of claim 1, wherein the computer is at least one of a smart phone, a dedicated GPS device, and in a vehicle.

4. The system of claim 1, wherein the first portion of the route is indicated by at least one of a landmark, a portion of the route, and a governmental boundary.

5. The system of claim 4 wherein the first portion of the route is further indicated by geo-coordinates.

6. The system of claim 1, wherein the computer is further configured to determine when the vehicle has deviated from the route, and, upon determining that the vehicle has deviated from the route, to request user input concerning whether to provide audio navigational assistance.

7. The system of claim 1, wherein the custom route data is provided by user input specifying a location in the route at which audio navigational assistance is to begin.

8. A method, comprising:
receiving input to generate a route;
generating the route according to the input;
receiving custom route data indicating a first portion of the route, the first portion of the route being a portion of the route for which audio navigational assistance is to be provided;
provide navigational instructions as the route is traversed, wherein audio navigational assistance is provided for the first portion but not a second portion of the route.

9. The method of claim 8, wherein the first portion of the route includes one of a start point of the route and an end point of the route.

10. The method of claim 8, wherein the navigation assistance is provided via at least one of a smart phone, a dedicated GPS device, and computer in a vehicle.

11. The method of claim 8, wherein the first portion of the route is indicated by at least one of a landmark, a portion of the route, and a governmental boundary.

12. The method of claim 11, wherein the first portion of the route is further indicated by geo-coordinates.

13. The method of claim 8, wherein the computer is further configured to determine when the vehicle has deviated from the route, and, upon determining that the vehicle has deviated from the route, to request user input concerning whether to provide audio navigational assistance.

14. The method of claim 8, wherein the first portion of the route is indicated by user input specifying a location in the route at which audio navigational assistance is to begin.

15. A non-transitory computer-readable medium including tangibly embodied thereon instructions executable by a processor, the instructions comprising instructions for:
receiving input to generate a route;
generating the route according to the input;
receiving custom route data indicating a first portion of the route, the first portion of the route being a portion of the route for which audio navigational assistance is to be provided;
provide navigational instructions as the route is traversed, wherein audio navigational assistance is provided for the first portion but not a second portion of the route.

16. The medium of claim 15, wherein the first portion of the route includes one of a start point of the route and an end point of the route.

17. The medium of claim 15, wherein the first portion of the route is indicated by at least one of a landmark, a portion of the route, and a governmental boundary.

18. The medium of claim 17, wherein the first portion of the route is further indicated by geo-coordinates.

19. The medium of claim 15, wherein the computer is further configured to determine when the vehicle has deviated from the route, and, upon determining that the vehicle has deviated from the route, to request user input concerning whether to provide audio navigational assistance.

20. The medium of claim 15, wherein the first portion of the route is indicated by user input specifying a location in the route at which audio navigational assistance is to begin.
